(19) United States
(12) Patent Application Publication
(10) Pub. No.: US 2022/0106976 A1
(43) Pub. Date: Apr. 7, 2022

(54) LOCK WASHER FOR A SCREW CONNECTION, AND SCREW CONNECTION

(71) Applicant: Adolf Schnorr GmbH & Co. KG, Sindelfingen (DE)

(72) Inventor: Christoph SEYBOLDT, Stuttgart (DE)

(21) Appl. No.: 17/490,235

(22) Filed: Sep. 30, 2021

(30) Foreign Application Priority Data
Oct. 7, 2020 (DE) 10 2020 126 247.7

(51) Int. Cl. F16B 39/24; F16B 31/04

(52) U.S. Cl. CPC F16B 39/24; F16B 31/04

(57) ABSTRACT

A lock washer for a screw connection between a screw part and a component, having an annular washer body which is delimited by a peripheral outer rim and an inner rim, having a receiving bore, delimited by the inner rim, into which the screw part is insertable, having an upper annular surface which is provided on an upper side of the washer body and has a toothing, having a lower annular surface which is provided on a lower side of the washer body and has a toothing which extends fully on the lower annular surface, wherein the toothing on the upper annular surface extends fully circumferential in a toothed region, the width of the toothed region on the upper annular surface is smaller than the width of the washer body between the outer rim and the inner rim, and an untoothed region is formed on the upper annular surface between the toothed region and the outer rim of the washer body.

The invention relates to a lock washer for a screw connection between a screw part and a component and to a screw connection in which a screwed part can be fastened to a component with the interposition of a lock washer.

Lock washers, in particular toothed lock washers, are known from AT 207 179 B and DE 44 25 837 A1. Such a lock washer comprises an annular washer body delimited by an outer rim and an inner rim running concentrically in relation thereto. A receiving bore is provided in the washer body, which receiving bore is delimited by the inner rim, in order to receive a screwed part. This washer body comprises an upper and a lower annular surface, each of which has a toothing throughout on the upper and lower annular surface. This washer body has a flattening on its upper annular surface between the toothing and the inner rim. On the opposite side, a flattening is also provided on the lower annular surface between the toothing and the outer rim. The lock washer is curved like a plate spring, which means that the washer body is raised. Before a screwed connection is tightened, the lock washer rests on a component in the untensioned state with the flattening adjacent to the outer peripheral edge. The flattening on the upper side of the lock washer adjacent to the inner peripheral edge is in contact with a screw head.

Such lock washers have proved themselves in use. In particular, screw connections where the hardness of the component is greater than 200 HV (Vickers Hardness).

A screw lock for a screw connection is known from DE 10 2005 054 471 A1. This screw lock comprises two wedge-shaped washers, which each have a wedge-shaped profile on the end faces facing each other. An anti-rotation profile is provided on each outer side of the wedge-shaped washers. This screw lock always requires two washers for locking the screw connection, which must be matched to each other with regard to the wedge-shaped profile so that they engage in each other for locking. An analogous design of the screw connection is known from U.S. Pat. No. 4,134,438 A.

US 2009/0036224 A discloses a method for producing such an aforementioned screw connection, consisting of a wedge-shaped washer pair.

The requirements for such screw connections are increasing and also require securing of a screw connection in the case of a component having a soft surface, such as aluminium, or a reduced bearing surface of the screwed part, such as with elongated holes.

The object of the invention is to propose a lock washer and a screw connection providing a sufficient form and force fit between the lock washer and the component or between the screw part and the component with the interposition of the lock washer.

This object is solved by a lock washer for a screw connection between a screw part and a component, in which the toothing on the upper annular surface extends within a toothed region which is formed fully peripherally and in which a width of the toothed region on the upper annular surface is smaller than the width of the washer body between the outer rim and the inner rim and in which an untoothed region is formed on the upper annular surface between the toothed region and the outer rim of the washer body.

This enables a smaller surface pressure to be applied to the lower screw partner by the lock washer during a screw connection is made with the same pre-tensioning force of the screw connection, as a result of which the toothing on the lower annular surface of the lock washer digs into the soft surface of the component to the extent necessary to secure the screw connection. At the same time, the toothing on the upper annular surface of the lock washer digs into the screw part, whereby a complete form and force fit of the screw connection is achieved.

Furthermore, it is preferably provided that the width of the toothed region on the upper annular surface is smaller than the width of the toothed region on the lower annular surface.

Preferably, it is provided that the toothed region formed on the upper annular surface is formed as a peripheral strip and an untoothed region is formed on the upper annular surface, which extends fully peripherally and is formed as a strip. Thus, a combination of a toothed region and an untoothed region is provided on an upper annular surface of the washer body. These two regions are preferably fully peripheral and strip-shaped.

It is preferably provided that the toothed region on the upper annular surface of the washer body is surrounded by the untoothed region at least on one side. Thus, in particular, the region of the washer body is provided with a toothed region, which cooperates with the screw part when a screw connection is made.

According to a preferred embodiment of the lock washer, it is provided that the toothed region on the upper annular surface adjoins the inner rim of the washer body and extends only partially to the outer rim and is delimited by the untoothed region, which extends from the toothed region to the outer rim. Thus, only two regions differing from each other are formed on the upper annular surface.

According to a preferred embodiment of the upper annular surface of the lock washer, the width of the toothed region is greater than that of the untoothed region. This makes it possible to achieve an increased form fit. According to an alternative embodiment, it can be provided that, for some applications, the width of the toothed region and that of the untoothed region on the upper annular surface of the washer body are the same. In the case of particularly soft surfaces of the component, it can be provided that a lock washer is used in which the width of the toothed region is smaller than that of the untoothed region.

According to a further preferred design of a lock washer, it is provided that this has a setted up washer body in which an inner rim is raised relative to the outer rim, wherein, in an unclamped state, the outer rim of the lower annular surface rests on the component and the inner rim of the upper annular surface is provided to rest against the screw part. As a result, the lock washer can be designed in the manner of a plate spring when viewed in cross-section and additionally provide a pre-tensioning force when the screw connection is made.

A further advantageous design of the lock washer provides that the lower annular surface has a flattening adjacent to the outer rim, which forms an outer circular boundary for the toothing on the lower annular surface, which extends to the inner rim. Such a flattening can be provided in analogy on the upper annular surface adjacent to the inner rim. This enables improved application of the pre-tensioning force at the start of the fastening of the screwed part to the component.

A further preferred embodiment of the lock washer provides that the washer body is made of a spring steel or a high-strength or heat-resistant or corrosion-resistant steel, in particular steel with corrosion-resistant nickel-based alloys, which preferably has a hardness of greater than 200 HV (Vickers Hardness).

The object of the invention is further solved by a screw connection with a component and a screw part which is fastenable thereto and which is designed as a screw or a screw/nut combination, as well as at least one lock washer positioned between the component and the screw part, in which a lock washer according to one of the above-described embodiments is used. A screw connection having such a lock washer can be used for slotted hole connections, enlarged through holes as well as for soft surfaces of a component in order to create a secure screw connection.

Preferably, it is provided that the component is made of steel, a light metal alloy or a plastic having a surface hardness less than equal to 200 HV. The lock washers themselves can have a surface hardness of greater than 200 HV. Such a pairing, in particular with an upper annular surface of the lock washer, which comprises a toothed and untoothed region, can provide adequate locking even for components with a soft surface.

Advantageously, it is provided that the width of the toothed region on the upper annular surface of the washer body is greater than or equal to a diameter of a screw head or a peripheral surface on the underside of the screw head. The outer diameter of the lock washer is advantageously enlarged compared to the outer circumference of the screw head. This allows the surface pressure between the toothing on the lower annular surface and the component to be reduced. This in turn has the advantage that the toothing does not dig too deeply into the surface of the component.

Furthermore, it is preferably provided that the screw part is subjected to a pre-tensioning force to the component for locking the screw part, and a lock washer is provided in which the size of the annular surface is enlarged such that, with the pre-tensioning force for securing the screw part to the component, the effective surface pressure, which results from the pre-tensioning force divided by the annular surface of the lock washer, has a value of less than 200 N/mm². By increasing the outer diameter of the lock washer compared with standardised lock washers, it is possible to reduce the effective surface pressure. This is particularly advantageous in the case of soft materials, preferably those with a hardness of equal to or less than 200 HV, since this can counteract the lock washer digging in too deeply in the component. Nevertheless, sufficient locking in place against independent loosening is made possible due to the engagement of the toothing of the lock washer in the component.

The invention and other advantageous embodiments and developments thereof are described and explained in more detail below using examples depicted in the drawings. The features to be taken from the description and the drawings can be applied individually or in any combination in accordance with the invention. Here are shown:

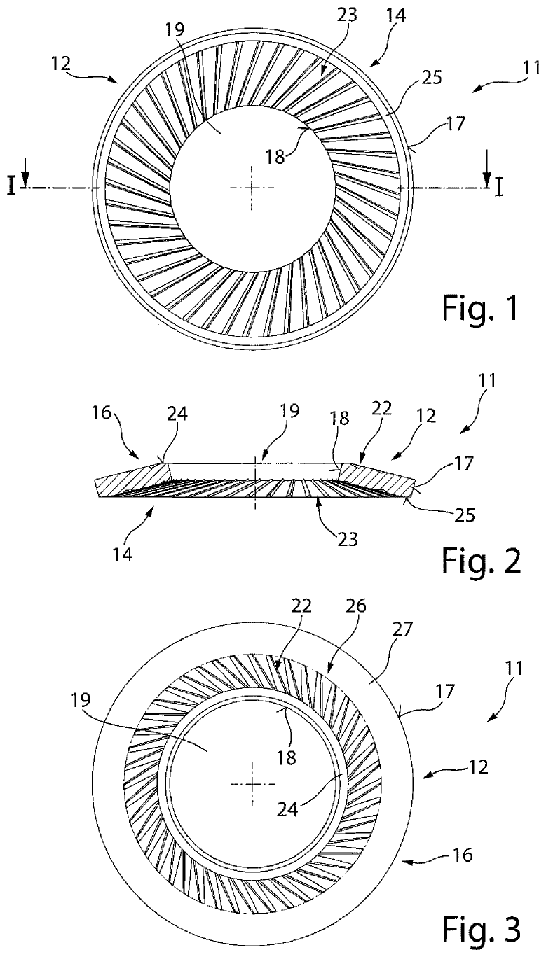

FIG. 1 a schematic view of an underside of a lock washer,

FIG. 2 a schematic sectional view of the lock washer according to FIG. 1,

FIG. 3 a schematic view from above of the lock washer according to FIG. 1,

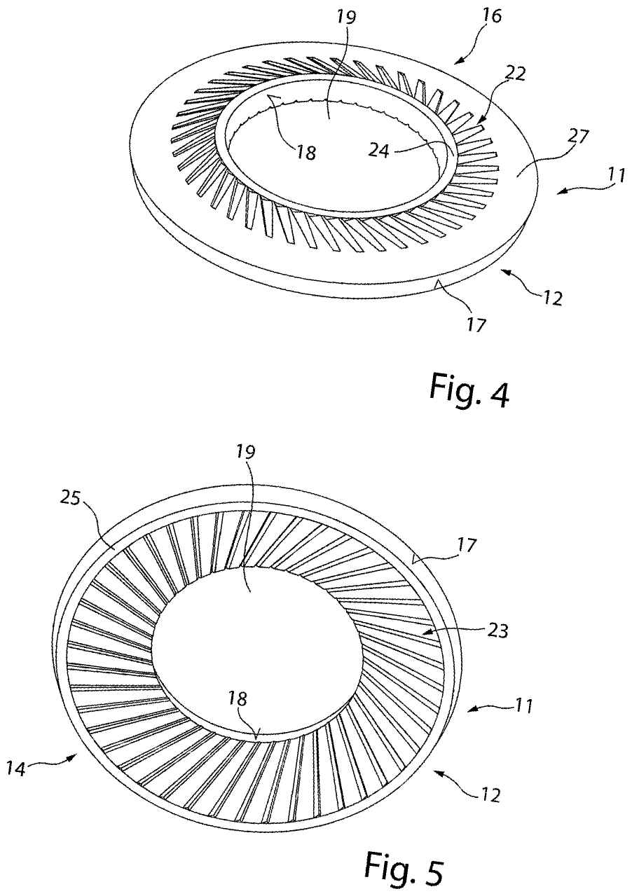

FIG. 4 a perspective view from above of the lock washer according to FIG. 1,

FIG. 5 a perspective view from below of the lock washer according to FIG. 1,

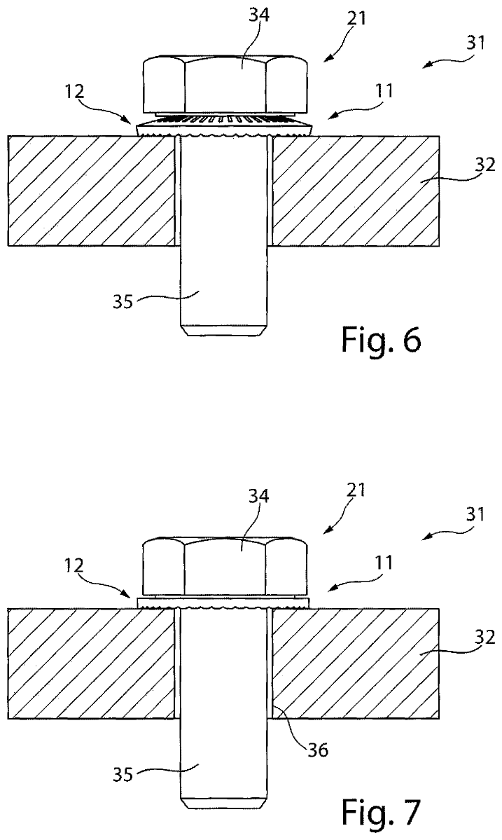

FIG. 6 a schematic sectional view of a screw connection in the untensioned state,

FIG. 7 a schematic sectional view of the screw connection according to FIG. 6 in the tensioned state,

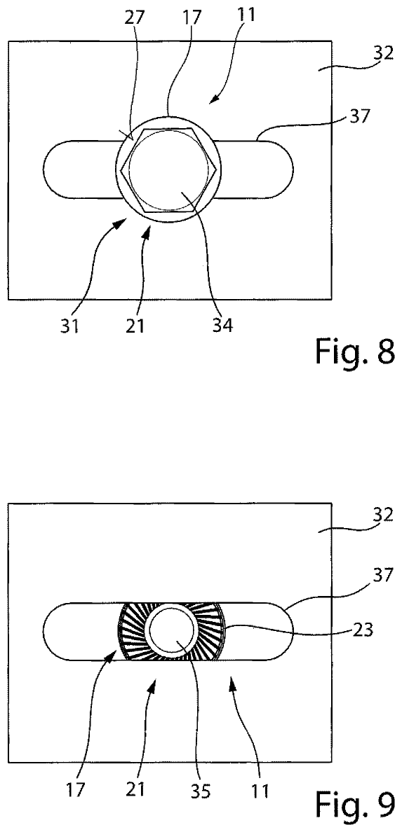

FIG. 8 a schematic view from above of an alternative screw connection, and

FIG. 9 a schematic view from below of the screw connection according to FIG. 8.

FIG. 1 depicts a schematic view from below of a lock washer 11. FIG. 2 shows a schematic sectional view along the line I-I in FIG. 1. FIG. 3 shows a schematic view from above of the lock washer 11 according to FIG. 1. FIG. 4 shows a perspective view from above and FIG. 5 shows a perspective view from below of the lock washer 11 according to FIG. 1.

This lock washer 11 comprises a washer body 12, which is annularly formed. This washer body 12 comprises a lower annular surface 14, which is depicted in FIG. 1, and an upper annular surface 16, which is depicted in FIG. 3. The upper and lower annular surfaces 14, 16 are each delimited by a peripheral outer rim 17 and a preferably concentric inner rim 18. The inner rim 18 delimits a receiving bore 19, which is provided for the insertion of a screw part 21 (FIG. 4). A toothing 23 is provided on the inner annular surface 14, which extends fully peripherally. Furthermore, the toothing 23 extends over the entire width of the annular surface 14, namely from the inner rim 18 to the outer rim 17.

Adjacent to the outer rim 17 and in the direction of the toothing 23, a lower flattening 25 is provided, such that the teeth of the toothing 23 adjacent to the outer rim 17 are flattened. The flattening 25 can be even or rounded. The toothing 23 on the lower side is preferably formed as a helical toothing. Such a toothing 23 can be produced by stamping.

The lock washer 11 according to FIGS. 1 to 3 preferably has an upright washer body 12. This is shown in the sectional view according to FIG. 2. The washer body 12 is formed in the manner of a plate spring. An inner rim 18 of the washer body 12 is raised relative to an outer rim 17. This enables this lock washer 11 to generate a tensioning force acting on a screw connection.

The top view of the upper annular surface 16 of the lock washer 11 shows that a toothed region 26 and an untoothed region 27 are provided. The toothed region 26 comprises a toothing 22 extending fully within the toothed region 26. This toothed region 26 on the upper annular surface 16 is smaller in width, in any case, than the width of the upper annular surface 16 that is, between the outer rim 17 and the inner rim 16. The width of the toothed region 26 within which the toothing 22 extends is formed to be smaller than the toothing 23 on the lower annular surface 14, which extends on the lower annular surface 16 between the inner rim 18 and the outer rim 17. The toothed region 26 extends fully circumferential on the upper annular surface 16. The toothed region 26 can merge into an upper flattening 24 extending to the inner rim 18. From there, the toothed region 26 extends, as seen in the width, in the direction of the outer rim 17. Between the toothed region 26 and the outer rim 17 of the washer body 12, the untoothed region 27 extends fully peripherally. This untoothed region 27 advantageously has a flat surface. The width of the toothed region 26 or that of the untoothed region 27 can be selected depending on the hardness of the surface of the component 32. The width of the toothed region 26 can be equal to, greater than or less than the width of the untoothed region 27. The toothed region 26 is preferably also designed as a helical toothing. The design of the helical toothing can be the same for both the lower annular surface 14 and the toothed region 26 of the upper annular surface 16.

The lock washer 11 is preferably made of a spring steel, a high-strength or a heat-resistant or corrosion-resistant steel. The lock washer 11 can have a hardness of greater than 200 HV.

FIG. 6 shows a screw connection 31 in an untensioned state between a component 32 and the screw part 21 with the interposition of the lock washer 11. In this first embodiment, the screw part 21 is designed as a screw with a screw head 34 and a thread 35. Alternatively, the screw part 21 can also be formed as a threaded pin having a nut attached thereto. In these cases, the component 32 comprises a threaded hole 36. Alternatively, it can be provided that the component 32 comprises a through hole such that another component not depicted in more detail can be fastened or held by a screw connection 31 having a screw part 21 comprising a screw/nut combination or a threaded pin/nut combination.

The screw head 34 of the screw part 21 preferably has a peripheral flat annular collar on its side facing the lock washer 11. The width of the toothed region 26 on the upper annular surface 16 of the lock washer 11 preferably corresponds to the width of the annular collar on the underside of the screw part 21. The untoothed region 27 extends radially peripherally beyond the underside of the screw part 21. The outer rim 17 of the lock screw 11 is larger in diameter than the screw head 34 of the screw part 21.

In the tensioned state of the lock washer 11 according to FIG. 7, the toothing 23 engages positively on one surface of the component 32. On the opposite side, a form fit is achieved between the toothed region 26 of the lock washer 11 and a screw head or the annular collar of the screw head 34 of the screw part 21. In addition, the lock washer 11 provides a complete force fit of the screw connection between the component 32 and screw part 21 due to the plate spring-like curved geometry.

FIG. 8 depicts a schematic view from above and FIG. 9 depicts a schematic view from below of an alternative embodiment of the screw connection 31. In this embodiment, the component 32 surrounds an elongated hole 37. The enlarged outer diameter of the lock washer 11 has the advantage that a lower annular surface 14 is supported on the component 32 adjacent to the elongated hole 37 and can achieve a secure form fit connection. The toothed region 26 on the upper side of the lock washer 11 corresponds in width, for example, to the outer circumference of a lower side of the screw part 11.

1. A lock washer for a screw connection between a screw part and a component,
having an annular washer body which is delimited by a peripheral outer rim and an inner rim,
having a receiving bore, delimited by the inner rim, into which the screw part is insertable,
having an upper annular surface which is provided on an upper side of the washer body and has a toothing,
having a lower annular surface which is provided on a lower side of the washer body and has a toothing which extends fully on the lower annular surface,
wherein
the toothing on the upper annular surface extends fully circumferential in a toothed region,
the width of the toothed region on the upper annular surface is smaller than the width of the washer body between the outer rim and the inner rim, and
an untoothed region is formed on the upper annular surface between the toothed region and the outer rim of the washer body.

2. The lock washer according to claim 1, wherein the width of the toothed region on the upper annular surface is smaller than the width of the toothing on the lower annular surface.

3. The lock washer according to claim 1, wherein the toothed region is surrounded on one side by the untoothed region.

4. The lock washer according to claim 1, wherein the toothed region on the upper annular surface extends from the inner rim of the washer body only partially to the outer rim and is delimited by the untoothed region which extends from the toothed region to the outer rim of the washer body.

5. The lock washer according to claim 1, wherein the width of the toothed region is greater than that of the untoothed region, or the width of the toothed region is equal to the width of the untoothed region, or the width of the toothed region is smaller than the width of the untoothed region.

6. The lock washer according to claim 1, wherein the washer body is set up in the manner of a plate spring.

7. The lock washer according to claim 1, wherein the toothing on the upper and/or lower annular surface is formed as a helical toothing.

8. The lock washer according to claim 1, wherein the untoothed region is formed as a flat surface.

9. The lock washer according to claim 1, wherein a flattening is provided on the lower annular surface adjacent to the outer rim, which flattening provides an outer circular boundary for the toothing, which extends to the inner rim.

10. The lock washer according to claim 1, wherein the upper annular surface has, adjacent to the inner rim, a flattening which forms an inner circular boundary for the toothed region, which extends to the untoothed region.

11. The lock washer according to claim 1, wherein the washer body is made of a spring steel, a high-strength or heat-resistant or corrosion-resistant steel.

12. The lock washer according to claim 1, wherein the washer body has a hardness of equal to or greater than 200 HV.

13. A screw connection having a component and a screw part fastened thereto, which is formed as a screw and/or a screw/nut combination, and at least one lock washer positioned between the component and the screw part, wherein the lock washer is formed according to claim 1.

14. The screw connection according to claim 13, wherein the component is made of a steel, a light metal alloy or a plastic with a surface hardness of equal to or less than 200 HV.

15. The screw connection according to claim 13, wherein the component has a threaded hole, a through hole or an elongated hole.

16. The screw connection according to claim 13, wherein the width of the toothed region on the upper annular surface of the washer body is equal to or greater than a diameter of a screw head or a peripheral surface on the underside of the screw head of the screw part.

17. The screw connection according to claim 13, wherein the screw part is subjected to a pre-tensioning force to the component for locking the screw part, and a lock washer is provided, in which the size of the annular surface of the lock washer is enlarged such that, with the pre-tensioning force for securing the screw part to the component, the effective surface pressure, which results from the pre-tensioning force divided by the annular surface of the lock washer, has a value of less than 200 N/mm².
